(19) United States
(12) Patent Application Publication
(10) Pub. No.: US 2026/0233048 A1
(43) Pub. Date: Aug. 13, 2026

(54) A STABLE PLAYGROUND APPARATUS

(71) Applicant: SYSTEMS IP PTY LTD, Queensland (AU)

(72) Inventors: Joe Andon, Queensland (AU); Akira Yamada, Queensland (AU); Michael Williams, Queensland (AU)

(21) Appl. No.: 19/469,938

(22) PCT Filed: Apr. 1, 2024
(86) PCT No.: PCT/AU2024/050305

§ 371 Date: Sep. 26, 2025

(30) Foreign Application Priority Data
Apr. 1, 2023 (AU) 2023900931

(51) Int. Cl. A63B 9/00

(52) U.S. Cl. CPC A63B 9/00; A63B 2009/006

(57) ABSTRACT

A playground apparatus is provided comprising a frame structure formed from a plurality of upright support poles, and a plurality of horizontal bars configured for a user to climb or swing. The upright support poles and horizontal bars form at least one quadrilateral having four corners wherein cross bracing is provided in the quadrilateral to reduce or prevent unwanted movement of the quadrilateral during use.

The present document claims priority to AU2023900931 entitled: A stable playground apparatus, filed on 1 Apr. 2204 the contents of which are hereby incorporated by reference in their entirety.

### TECHNICAL FIELD

The present invention relates to a playground apparatus.

### BACKGROUND

Children are naturally energetic and enjoy engaging in physical activities such as climbing and swinging. It is not uncommon to witness children scaling public railings or fences or even hanging upside down from them. However, playgrounds are equipped with specially designed equipment like monkey bars that offer a safe and exciting environment for children to explore their curiosity and physical abilities. These structures can be placed in designated play areas to divert children's attention from potentially unsafe locations such as railings, gates, or fences.

Monkey bars are a popular feature in playgrounds and residential backyards. They consist of a series of ladders, bars, and other attachments that are designed to attract children and keep them engaged. The name “monkey bars” comes from the fact that children can climb across them like monkeys. The poles of these structures are constructed to ensure safety, with smooth surfaces and no sharp edges or snags that may harm children.

It is crucial for playground apparatus such as monkey bars to be structurally stable to ensure the safety of children who use them. A poorly designed or maintained monkey bar structure can pose a significant risk of injury to children, which can range from minor cuts and bruises to more severe injuries such as broken bones or head injuries. Other playground apparatus that should be stable include general climbing frames and swing sets.

Playground apparatus that are not stable may wobble or sway, making it difficult for children to maintain their balance if climbing and potentially causing them to fall. In addition, a structure that is not properly anchored to the ground or has loose bolts or screws may collapse, leading to serious injuries.

It is essential, therefore, that playground apparatus such as monkey bars, climbing frames or swing sets are constructed with high-quality materials and designed to withstand the weight and force of children climbing and swinging on them. They should also be inspected regularly to ensure that all components are in good condition and that there are no signs of wear and tear that may compromise their stability.

By ensuring that playground apparatus are structurally stable, parents, teachers, and caregivers can provide children with a safe and fun environment for physical activity, promoting their physical development and overall well-being.

### SUMMARY OF INVENTION

A playground apparatus comprising:
a frame structure formed from a plurality of upright support poles, and a plurality of horizontal bars configured for a user to climb or swing,
the upright support poles and horizontal bars forming at least one quadrilateral in the frame, the quadrilateral having four corners;
wherein cross bracing is provided in the quadrilateral to reduce or prevent unwanted movement of the quadrilateral at the four corners during use.

Cross bracing can provide additional support and stability to the playground frame structure when compared to a playground apparatus that does not use the cross bracing. It is thought that the cross brace addition allows the apparatus to obtain a higher level of safety and security as it takes the wobble out of the playground apparatus' which is found across the market. By increasing product stability, there is an increase in product safety, which is a unique selling point which is not offered in the present market. The current industry ‘feature driven solution’ to the instability problem is the use of outriggers. Outriggers are not effective enough in reducing wobble in the playground apparatus. Thus, the present solution is desirable across the industry as it is vastly superior than outriggers and takes less space in the customers back yard.

The present apparatus requires a quadrilateral in the frame which can be formed by a pair of spaced apart upright poles joined by an upper horizontal bar and a lower horizontal bar. The quadrilateral can be a stabilisable quadrilateral being one which can provide stability once braced. Previously playground structures did not make use of cross bracing because there was no stabilisable quadrilateral formed in the frame of the playground apparatus. The lower horizontal bar of any such stabilisable quadrilateral presents a tripping hazard in playground apparatus, so the skilled person is taught to omit it. However, the present inventors have found that without the lower horizontal bar to form the quadrilateral that can be stabilised, the cross-bracing will not take full effect. The lowermost horizontal bar is turned into a play feature via the cross brace system. Given that the lower horizontal bar can cause an obstruction, it may only be present at one of the faces of the playground apparatus.

In one or all embodiments, the cross bracing comprises diagonal members arranged between the main vertical support poles and the horizontal structural bar members of the apparatus. The diagonal members of the cross bracing can be arranged to form a series of X or V shapes that help to distribute forces evenly across the playground structure, making it stronger and more stable in use. The cross-bracing involves adding braces between the structural members of the apparatus to reinforce the playground structure and to reduce or substantially prevent the structure from wobbling or swaying during use.

The cross-bracing can be placed in different configurations depending on the specific design of the playground apparatus. Diagonal braces can be placed between the corners of the structure; however, it is also possible to use cross-bracing that is connected with and arranged between the upright support poles remote from the corners. Furthermore, in an embodiment, the cross-bracing is connected with and arranged between the horizontal support bars remote from the corners. While cross-bracing on the horizontal bars can provide additional stability, it may not be sufficient on its own to prevent wobbling of the playground apparatus. This is because the horizontal bars do not provide as much resistance against lateral or side-to-side forces. Accordingly, it is preferred that there is cross bracing in contact with and or between the vertical and horizontal bars. If the cross-bracing is in a spider web configuration, force applied by the bracing is not “directly’ from one corner. Accordingly, to improve stability, the spiderweb may be modified to include diagonal bracing while keeping the aesthetic appeal. In preferred embodiments, the cross-bracing engages with the corners of the structure. Connectors in the corners can be configured to receive the cross bracing.

Triangulation is the use of triangles in a structure to provide strength and stability. Cross bracing achieves triangulation by creating triangular shapes between the structural members of the apparatus (upright support poles and horizontal bar members), which help to distribute forces and prevent the structure from wobbling or swaying. Cross-bracing between the vertical and horizontal bars, forming a series of triangles, is generally most effective at providing stability to playground apparatus. This is because triangles are inherently stable shapes that can distribute forces evenly across the structure.

The key goal of cross-bracing is to provide additional support and stability to the structure by distributing forces evenly across the entire apparatus. The exact placement and configuration of the cross-bracing will depend on factors such as the size and shape of the apparatus, the materials used in its construction, and the forces it will be subjected to during use. Overall, the specific placement and configuration of cross-bracing will depend on the individual design and engineering considerations of the playground apparatus in question.

The playground apparatus can be a climbing structure. The playground apparatus can be a swing set which comprises a swing suspended from a frame structure. The playground apparatus can be monkey bars.

The playground apparatus includes upright support poles, and horizontal bars. In embodiments there are multiple upright support poles, and multiple horizontal bars. There can be any number of either of the poles and horizontal bars. The horizontal bars are arranged relative to the poles. By relative to the support poles it can mean that the horizontal bars are attached to the support poles so as to provide the frame arrangement.

The upright support poles are typically substantially vertical. The horizontal bars are typically substantially horizontal. Either sets of poles or horizontal bars can be disposed in any angular orientation offset from vertical or horizontal. For the horizontal bars in a climbing frame or monkey bar apparatus the arrangement can be any provided the user can grasp them with their hands and or leg, and swing and or rotate their body, or climb. The frame structure can include a main frame structure. The main frame structure can comprise four upright poles arranged in a square or rectangular configuration when viewed from above. This structure is like an open cube. In a swing set there may be an A frame with four uptight poles that connect to one another at the top.

The upright support poles are rigid structures once formed meaning that they do not move in use. The rigidity is provided by the strong material of the support poles. The rigid poles are also immobile which means that they do not move in use. There can be further upright poles to provide for more complex frame structure within the main frame structure. The horizontal bars can be arranged relative to the upright poles such as around and between the upright poles. The horizontal bars can be attached to the upright poles. The horizontal bars can be adjustably attached to the poles. Any configuration of horizontal bars can be designed to provide for excitement, aesthetic, function and or form. The playground apparatus can comprise one or more ladders for climbing to the top of the frame, and or one or more ladders arranged substantially horizontally (or offset from horizontal) relative to the frame, which the user can use to swing across “monkey style”. The playground apparatus can also include attachments such as trampoline(s) swing(s), slide(s), scramble net(s) or any other playground attachment that is desirable.

The upright support poles can be made of any material such as plastic or metal. The poles can be tubes. The poles can be of any cross-sectional shape. In an embodiment, the poles are tubular. In an embodiment, the poles are hollow. The poles can be smooth and easy to grip. The poles can comprise kinks to provide for an aesthetically pleasing, unusual or interesting frame.

The horizontal bars can be made of any material such as plastic or metal. The bars can be tubes or poles. The horizontal bars can be of any cross-sectional shape. In an embodiment, the horizontal bars are tubular. In an embodiment, the horizontal bars are hollow. The horizontal bars can be the same as or narrower in diameter than the support poles. The horizontal bars can be sized so as to be smooth and easy to grip. The horizontal bars can comprise kinks to provide for an aesthetically pleasing, unusual or interesting monkey bar frame.

The upright support poles and horizontal bars are attached to one another to form a frame. The poles or bars can be connected to one another by welding or other permanent joining technique. Alternatively, at least some of the connections between poles (pole to pole or pole to bar) can be by a connector such as a knuckle joint connector. The knuckle joint connector can allow for articulation about the joint. The join between poles can therefore be disposed at any angle during formation of the frame structure. Other connector or couplers can be used as desired.

At least one part of the frame comprises a quadrilateral. A quadrilateral is a polygon with four straight sides and four angles. Quadrilaterals include square, rectangle, parallelogram, rhombus and trapezoid. Each quadrilateral will be formed from two horizontal bars and two upright poles. Each of the horizontal bars and upright support poles can be formed in multiple joined pieces.

Preferably, to make best use of the cross bracing, the sides of the quadrilateral are approximately equal. In an embodiment, the sides of the quadrilateral do not differ from one another in length by more than 10, 20 or 30%. Stabilising a long thin rectangle in a frame structure will not be sufficient to improve overall stability. To ensure that the cross bracing has a significant impact on the overall stability of the playground apparatus, it is essential that the quadrilateral shape being stabilized is not too long or narrow. In fact, stabilising a quadrilateral that does not significantly contribute to the overall stability of the apparatus will not be enough to enhance its safety and structural integrity. It is important to design the apparatus with a quadrilateral shape that provides sufficient structural support to warrant the use of cross bracing. Thus, the quadrilateral that is braced in the frame is preferably one which will make a difference to the stability of the structure once stabilised. With this in mind, preferably, the quadrilateral is formed from the upright support poles that are around the outside edges of the structure, and are those typically fixed to the ground. The playground apparatus is formed from an open main frame, where each open frame side can be considered as a face. The key faces that are stabilised by the cross bracing are those that provide the most structural support. Typically, these are around the outside of the apparatus. In the main frame described above the four faces of the cube that forms are can be braced.

In an embodiment only one quadrilateral in the structure is braced. In an embodiment, more than one quadrilateral in the structure is braced. In an embodiment, all the main face quadrilaterals are braced. However, it should be understood that too much bracing will become inconvenient to the user who wants to run and swing around parts of the frame without colliding with the bracing.

Many playground apparatus have the upright support poles to form the frame, and many have the top horizonal bar. However, often a prior playground structure will not comprise the lower horizontal bar which is required by the present invention to complete the quadrilateral. Without the lower horizontal bar, the cross-bracing will not take effect. The lower horizontal bar is preferably providing structural support to the quadrilateral. The lower horizontal bar may be at most about 5, 10, 15, 20, 25, 30, 35, 40, 45 or 50 cm from the ground when the apparatus is constructed. If the lower bar is higher than this, the cross bracing may not be as effective. Given that the lower horizontal bar can cause an obstruction, it may only be present at one of the faces of the playground apparatus.

The cross-bracing can be provided by metal rods. The metal rods can be attached to the frame. The attachment to the frame can be through joiners. The attachment to the frame can be by welds to the upright poles and or the horizontal bars. The cross bracing can be provided by straps, such as nylon straps. While cross-bracing using ratchet straps is possible, such straps are designed for securing loads and typically have a lower weight capacity compared to other types of hardware used in playground equipment, such as bolts and clamps. Ratchet straps are not designed to handle constant stress and movement that is inherent in playground apparatus and may stretch over time or loosen with use, which could compromise the stability and safety of the equipment. In an alternative embodiment, straps, cables or wires can be tightened by turnbuckles. Turnbuckles are adjustable devices that can be used to apply tension to a wire or cable, allowing for precise adjustment of the tension in the cross-bracing. This can help ensure that the cross-bracing is tightened to the appropriate level, providing optimal stability for the apparatus.

In one or all embodiments, each of the bracing elements is a cable. The cable can be a steel cable core with a sheath. The sheath can be a nylon sheath. The cable can be a 16 mm, 6 strands combination rope. Each strand can be 4 to 5 mm or larger.

When used in the present playground apparatus, a turnbuckle can be attached to each corner of the frame, where it can be used to adjust the tension of the cross-bracing strap, wire, cable that runs diagonally from substantially corner to corner. Each turnbuckle can consist of a metal body that is designed to be bolted or screwed into the corner of the frame, with a threaded rod passing through the body. The rod is then attached to the cross-bracing wire using an eyelet that is also threaded, allowing the wire to be adjusted to the desired tension by turning the turnbuckle. By tightening or loosening the turnbuckle, the tension in the cross-bracing wire can be adjusted as needed to ensure that the apparatus is stable and safe for children to play on.

A central turnbuckle can also be used to provide additional stability to the playground apparatus. The central turnbuckle is typically positioned at the centre of the quadrilateral and all the braces are fed into it. The use of a central turnbuckle can also help distribute the weight of the apparatus evenly and prevent any one corner from bearing too much weight.

In an embodiment, without cross bracing support, the upright poles of the frame structure of the playground apparatus can move laterally upon application of applied pressure. One upright pole, not braced, can move up to about 5, 10 or 15 cm from its vertical resting position. This type of sway tends to result in customer complaints and dissatisfaction. With the cross bracing installed, the same upright pole can be reduced to moving at most about 1, 2, 3, 4, 5 6, 7 or 8 mm or less from its vertical resting position. This is a substantial reducing in lateral movement that may provide significant improvement in enjoyment of use of the apparatus.

The playground apparatus is intended for use on the ground. By ground it is meant any surface on which the apparatus is deployed. In some instances the ground could be grass and soil. In other instances, the ground can be concrete. The ground could be rubberised for safety. When arranged on the ground, the apparatus should be heavy enough to support its own weight. When a child (or multiple children) is/are playing on the apparatus, the frame should be strong enough to remain rigid and not be pulled over by the user. In some embodiments, the frame has upright poles with lower portions of the poles that are splayed. As a result of the splayed poles, the surface area covered by the base of the frame is larger than the surface area towards the top of the frame. This can improve the structural stability of the apparatus. The splaying angle can be 10, 15, 20 or 25 degrees from vertical. Not all of the upright pole legs need to be splayed nor do they have to be splayed in any consistent direction. In order to further improve stability, extension legs can be provided attached to the upright poles.

### BRIEF DESCRIPTION OF THE FIGURES

Embodiments of the invention will now be described with reference to the accompanying drawings which are not drawn to scale and which are exemplary only and in which:

FIG. 1 is a perspective view of a playground apparatus in the form of monkey bars according to an embodiment.

FIG. 2 is a photo of the cross bracing prior to tightening.

FIG. 3 is a photo of the cross bracing of FIG. 2 once tightened.

FIGS. 4 to 7 shows some designs of the cross bracing.

FIG. 8 shows the cross-bracing in an exemplary playground apparatus.

FIGS. 9a and 9b show the central turnbuckle.

FIGS. 10a and 10b show the rope being fed into a central turnbuckle.

FIGS. 11a and 11b show an alternative turnbuckle that can be used at the corners of the frame.

### DETAILED DESCRIPTION OF EMBODIMENTS OF THE INVENTION

Herein described is a playground apparatus which in an embodiment comprises monkey bars 10. An embodiment of monkey bars is shown for illustration purposes only, but it should be understood that other playground apparatus are in scope and many modifications could be made to the actual design, while still staying within the spirit and scope of the invention as described.

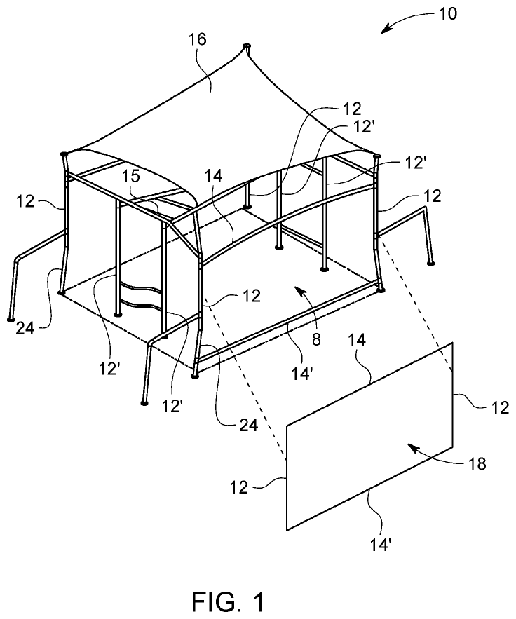

The frame structure of the monkey bar apparatus shown is provided by upright support poles 12. In the embodiment shown in FIG. 1, there are multiple upright poles 12, and multiple horizontal bars 14). The upright support poles 12 are typically substantially vertical. The horizontal bars 14 are typically substantially horizontal. It will be appreciated from FIG. 1, that the user can grab some of the horizontal bars 14 with their hands or legs and swing and or rotate their body, or climb around the structure 10.

A frame structure is provided by at least some of the poles 12. A dotted rectangle is depicted on FIG. 1 to shown schematically the area of the main frame structure on ground 8. The support poles 12 in the corners can provide the main frame structure. Other poles 12′ can be included that are still part of the frame, but which are intended to add complexity of the frame and to provide support for other horizontal bars 14′ which allow for climbing and play. In FIG. 1, other poles 12′ are supporting e.g. ladder horizontal bars 14 which a user can climb in order to reach the horizontally disposed ladder 15. The user can swing (like a monkey) across the ladder 15 enthusiastically until they reach the other side of apparatus 10. This swinging activity can be repeated many times in any direction.

The poles 12 and or horizontal bars 14 can be joined to one another by connectors. As shown in FIG. 1, a horizontal bar 14 can be formed by three smaller horizontal bars joined together to form a length of horizontal bar 14. There can be a cover 16.

The playground apparatus is shown on the ground 8. Each of the poles 12, 12′ that contact ground 8 can have a foot to increase the surface area of contact with the ground. Optionally, the poles can be splayed 24 as they meet the ground.

The quadrilateral 18 is shown exploded out from the main frame 10 for clarity. The quadrilateral 18 in this embodiment is a rectangle. The quadrilateral is formed from upper horizonal bar 14 and lower horizontal bar 14′. The quadrilateral is a face of the main frame 10 that provides structural support.

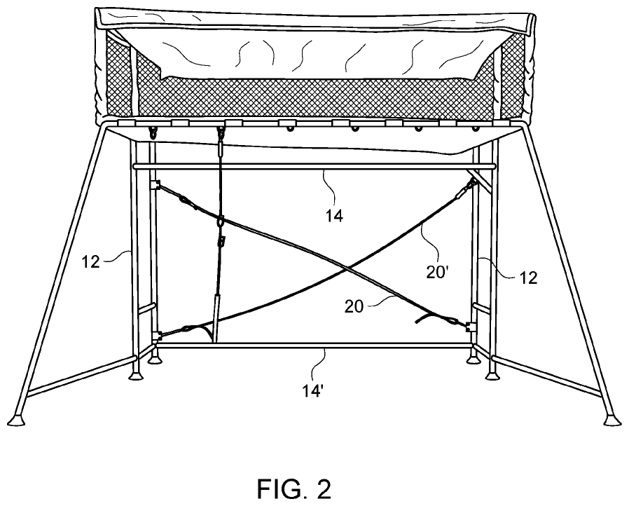

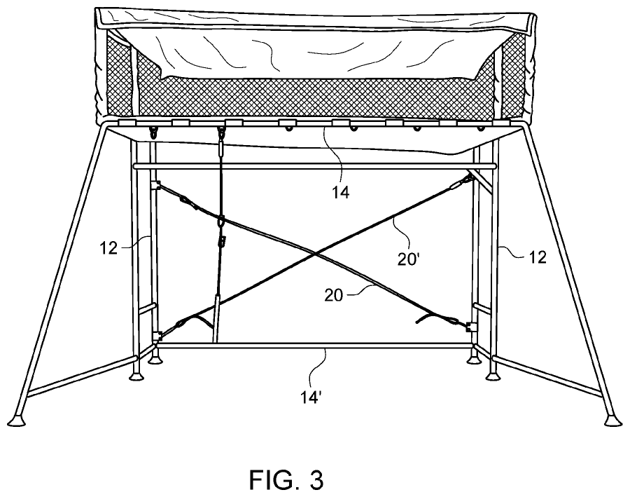

FIG. 2 is an embodiment in which the playground apparatus is a climbing frame with monkey bars and an enclosed area such as an overpass. FIG. 2 shows an embodiment of the cross bracing 20 comprised of first cable 20 and second cable 20′. The bracing is not yet tightened by the turnbuckles, so the frame can sway. In FIG. 3, the cross bracing 20 is applied tightly, and the sway is substantially reduced.

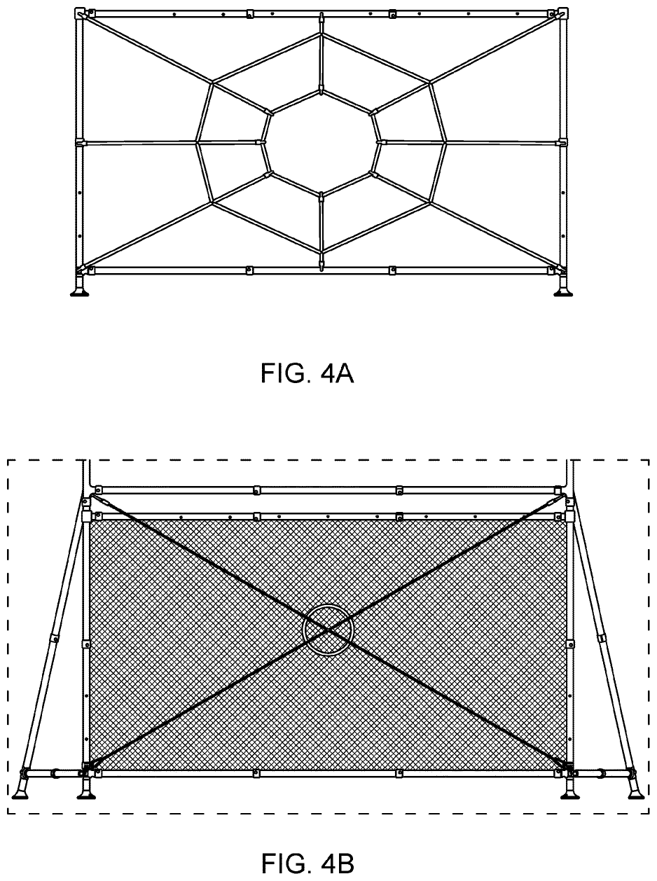

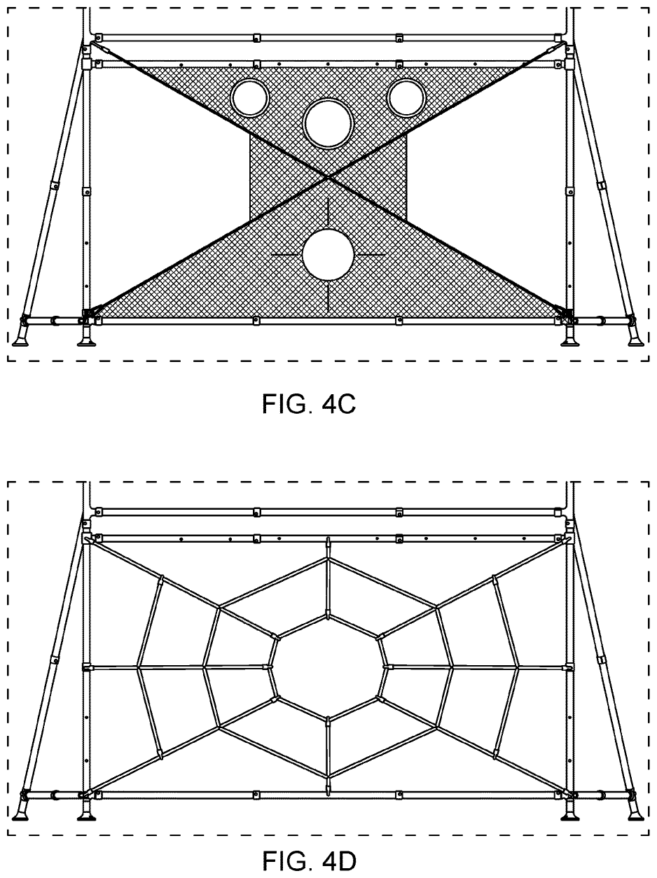

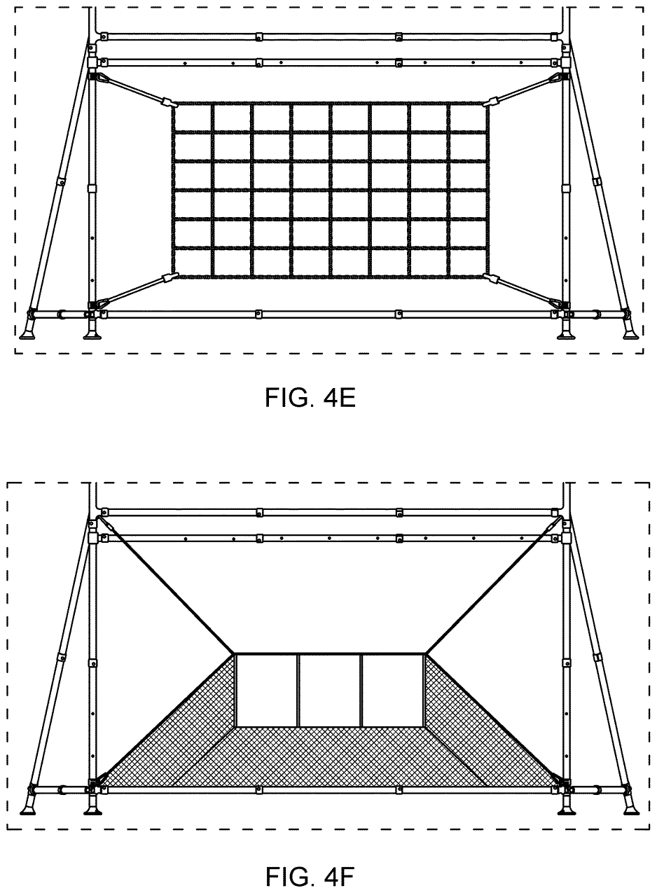

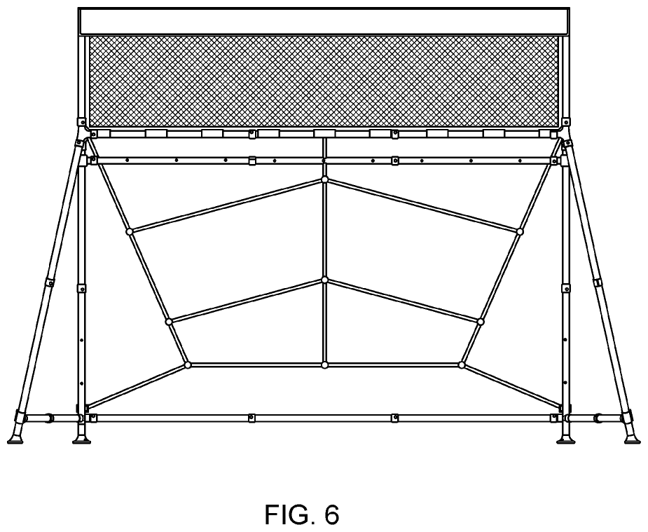

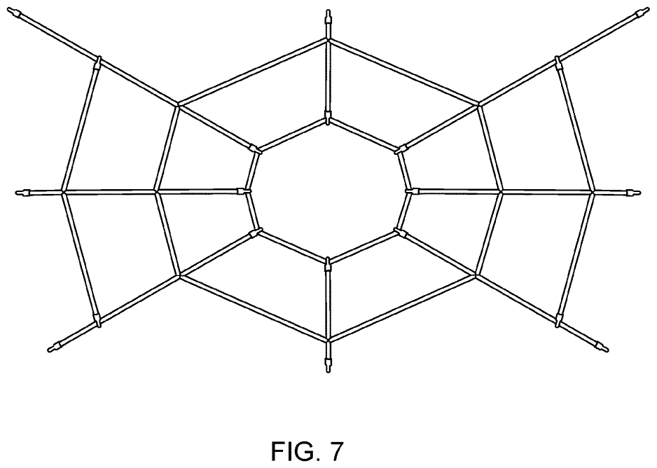

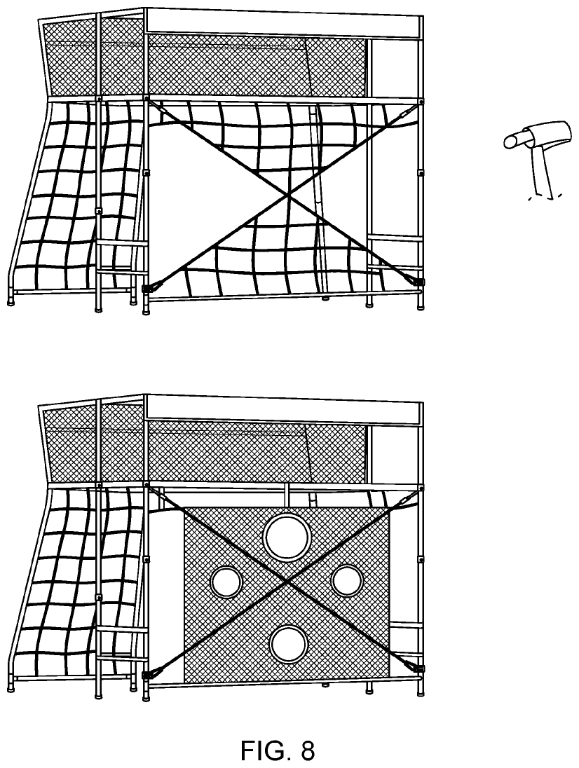

FIGS. 4 to 7 show some possible configurations of the cross bracing 20. The cross bracing can be present along with other ropes or netting that give an aesthetic feature on top of the function. Some of the members providing the cross bracing can be taking weight, while others of them are decorative. In embodiments, children will likely play on the cross bracing by e.g. climbing. As can be seen in FIG. 8, the cross bracing can be incorporated into fun play features that include ropes, openings or other fun features.

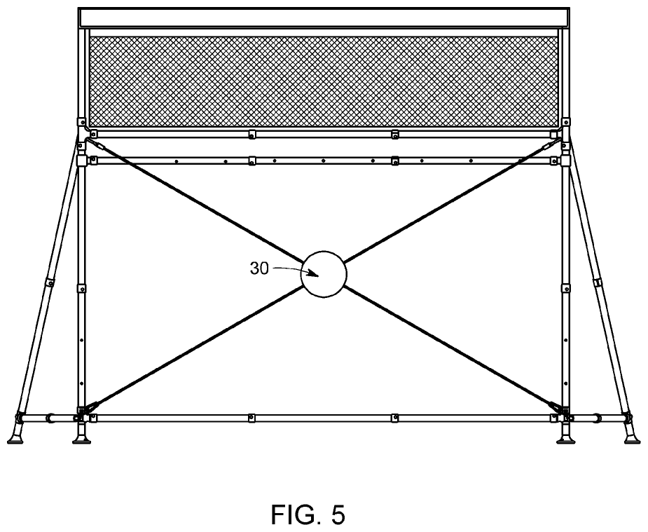

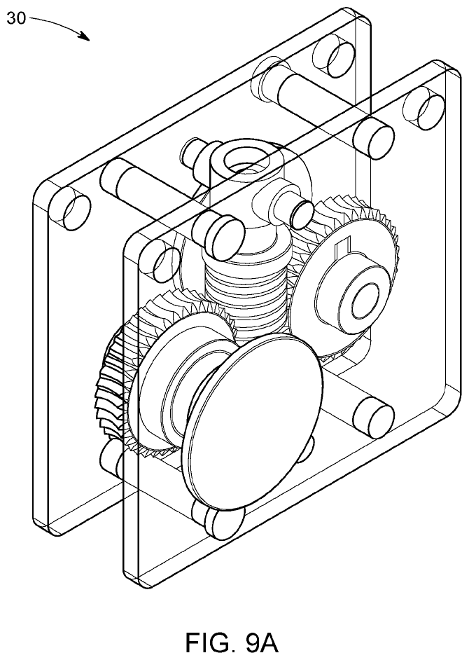

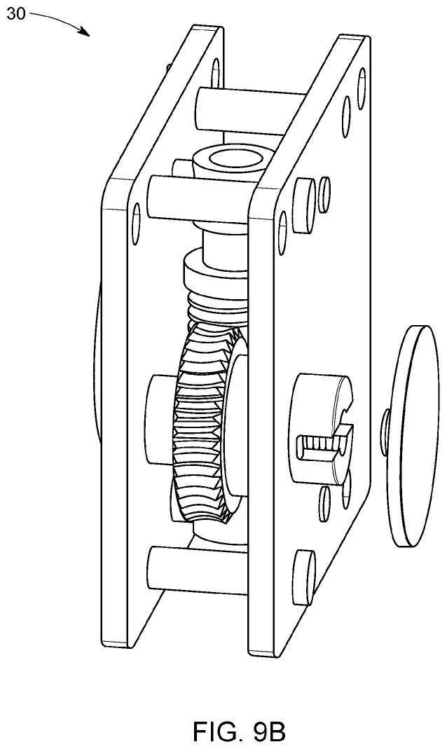

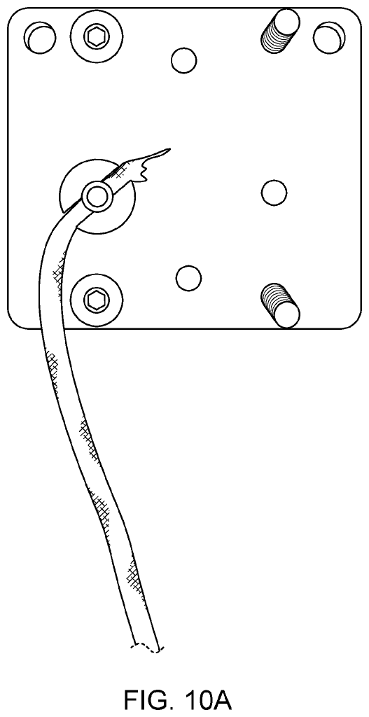

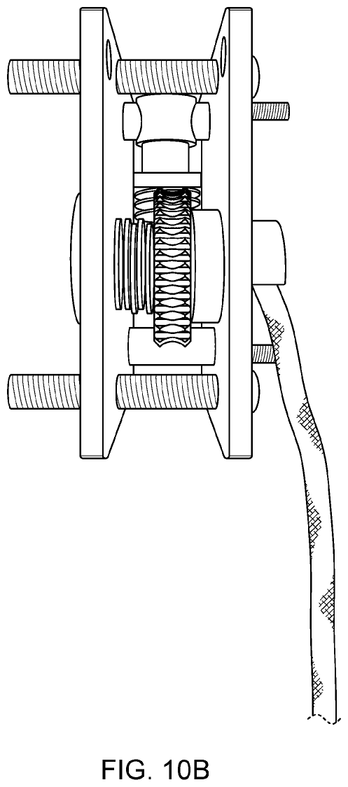

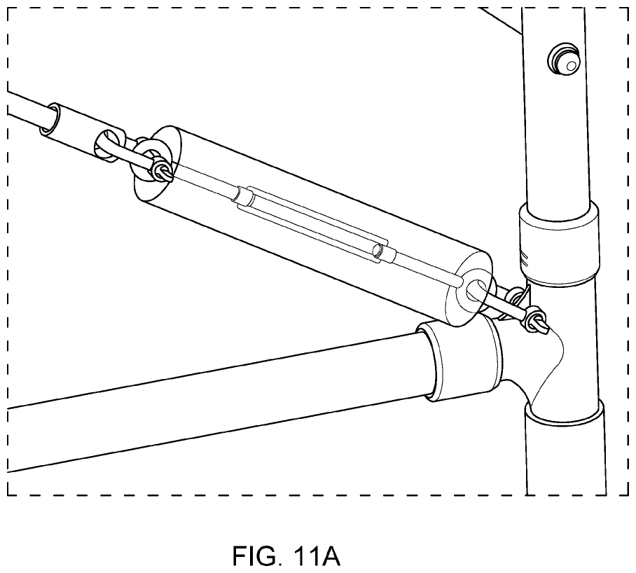

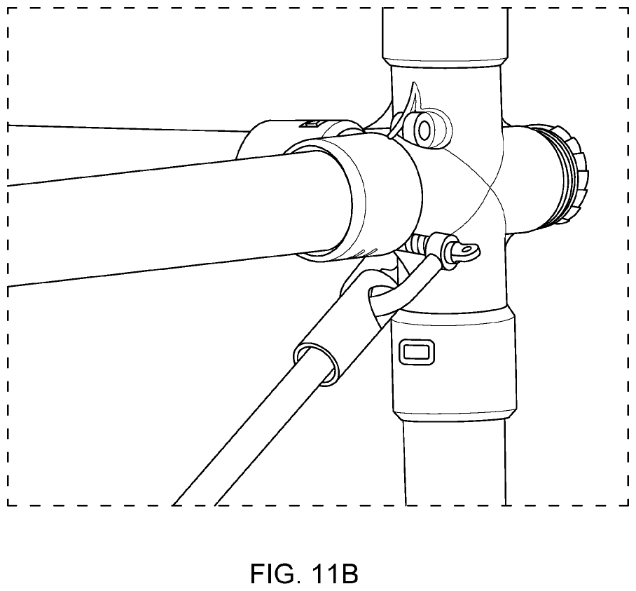

FIGS. 9a and 9b are inside views of the same central turnbuckle showing how the ropes are fed in and then held by crimpers. The location of the central turnbuckle 30 is shown in e.g. FIG. 5. As seen in FIGS. 10a, 10b, once the rope or cable is fed in, turning the turnbuckle will tighten it in one direction. A more traditional type of turnbuckle is shown in FIG. 11a and FIG. 11b which is an exemplary connection for the bracing of e.g. FIG. 3.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention, and are not intended to be promises made about the invention. Where there are promises that are deemed to apply to all embodiments of the invention, the right is reserved to later delete those promises from the description since there is no intention to rely on those promises for the acceptance or subsequent grant of a patent unless the context makes clear otherwise.

1-15. (canceled)

16. A playground apparatus comprising the following play features:
(i) a frame structure formed from a plurality of upright support poles, and a plurality of horizontal bars configured for a user to climb or swing,
the upright support poles and horizontal bars forming at least one quadrilateral in the frame, the quadrilateral having four corners;
wherein tightenable cross bracing is provided in the quadrilateral to reduce or prevent unwanted movement of the quadrilateral during use wherein the cross bracing extends as a diagonal support from each of the four corners of the frame structure
(ii) at least one play feature associated with the cross-bracing that can be climbed on and or through in use.

17. The playground apparatus of claim 16, wherein horizontal bars of the quadrilateral comprise an upper horizontal bar towards the top of the frame and a lower horizontal bar, and the lower horizontal bar is close to the ground.

18. The playground apparatus of claim 16, wherein the cross bracing comprises cables tightenable by turnbuckles.

19. The playground apparatus of claims 16 wherein the cross bracing is provided by brace members, such as cables, which are tightenable towards one another from the centre of the quadrilateral.

20. The playground apparatus of claim 16, wherein with the cross bracing installed, the upright support poles of the frame move about 2, 5 or 8 mm from its vertical resting position under applied forces.

21. The playground apparatus according to claim 16, wherein the at least one feature comprises one or more of: cables configured for climbing, cargo net and netting with openings configured for climbing through.

22. A kit comprising the components used to form the playground apparatus of claim 16 along with associated instructions on how to assemble the components to form the playground apparatus.
